(19) United States
(12) Patent Application Publication
(10) Pub. No.: US 2007/0198558 A1
(43) Pub. Date: Aug. 23, 2007

(54) Method and system of intelligent work management

(76) Inventor: Wen-Hsien Chen, Sijhih City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/509,788

(22) Filed: Aug. 25, 2006

(30) Foreign Application Priority Data
Aug. 26, 2005 (TW) 094129407
Aug. 23, 2006 (TW) 095130913

(51) Int. Cl. G06F 7/00

(52) U.S. Cl. 707/101

(57) ABSTRACT

An intelligent work management method comprises steps of providing a plurality of operation templates, and creating a project according to a selected one of the operation templates. The project has a plurality of real task items, each having an executive. The method further comprises a step of saving as a corresponding real task item with the executable status into a task pool so as to allow each of the executives to control his/her own real task items. The method can be carried out via a system. The system has a database, a task pool, a daily executable task pool, and a work management program. The work management program is provided for creating operation templates and projects into the database; and correspondingly creating an executable task item into the task pool according to the corresponding real task item with the executable status among the database; and correspondingly creating a daily task item into the daily executable task pool according to a respective one of the executable task items among the task pool.

### TECHNICAL FIELD

The present invention relates to an intelligent work management method and system associated with business administration, work plan and project management, and more particularly with database design, and computer program design.

### BACKGROUND OF THE INVENTION

Some actions to be taken happen in an enterprise everyday. In order to complete each of the actions efficiently, each of the actions is assigned to a project manager charging the same.

When being assigned with one of the actions, the project manager must take much time and attention to plan for the required action via dividing the action into a plurality of smaller or simpler sub-actions which are then assigned to different persons. Next, in the assistance of the project management software, a project and a plurality task items are created into a database in accordance with the required action and the sub-actions, and are monitored by the project management software, so that the required action is under control.

Many prior art techniques are found in Taiwan. Pat. No. 422,954, No. 459,190, No. 550,443, No. 571,214, No. 591,463, No. 591464, No. 59452, No. I 2242680, No. I225609, No. I230881 and No. I238961, which concern about work plan, work management, and work monitoring, and more particularly to management of the project executives and daily reports thereof. However, these prior arts do not resolve the problems mentioned above.

### SUMMARY OF INVENTION

The present invention is provided with an intelligent work management method that comprises a step of creating a plurality of operation templates in a database for a project manager to choose and pick. Each of the operation templates has a plurality of standardized task items. Once one of the operation templates is selected, a project is created into the database according to the selected operation template. The project includes a plurality of real task items each correspondingly created based upon each of the standardized task items of the selected operation template, and each of the real task items includes an executive.

Moreover, the intelligent work management method further comprises a step of creating an executable task item into a task pool according to an executable status of the corresponding real task item in the database. Or, the intelligent work management method may further comprises a step of creating a daily task item into a daily executable task pool according to a selected one of executable task items.

The present invention is further provided with an intelligent work management system for carrying out the method mentioned above. The intelligent work management system mainly comprises a data storage device for storing operation templates described above, an information processing device having a work management program for accessing in the data storage device, and wherein the work management program includes a project build module arranged for a project manager to select a matched operation template from the database according to a required action so as to correspondingly create a project and a plurality of real task items thereof into the database according to the selected operation template.

Wherein, the data storage device may further include a task pool and the work management program may further include a monitor module arranged for correspondingly creating an executable task item into the task pool according to the an executable status of the corresponding real task item in the database. In addition, the data storage device may further include a daily executable task pool and the work management program may further include a daily plan module arranged for each of executives to select at least one of the executable task items from the task pool, and to correspondingly create a daily task item into the daily executable task pool according to the selected executable task item.

Accordingly, once a required action happens, the project will be automatically created according to one of the operation templates among the database, and that greatly saves labor and/or time. In addition, each of the executives just need to manage the executable task items belonging to oneself in the task pool, without a need to take care of those real task items which have not yet entered into the executable status, and that alleviates management burdens of the executives. Furthermore, each of the executives can plan to estimate which ones of the executable task items should be executed that day according to the task pool, to correspondingly create the daily task items into the daily executable task pool according to the result of the plan, and to automatically generate a daily schedule work sheet according to the daily task items figured in the daily executable task pool.

### BRIEF DESCRIPTION OF DRAWINGS

FIG. 1 is a flowchart showing a preferred embodiment of a work management method according to the present invention;

FIG. 2 is a block diagram showing a database of the preferred embodiment;

FIG. 3 is a conceptual diagram showing an operation template of the preferred embodiment;

FIG. 4 is a conceptual diagram showing a project of the preferred embodiment;

FIG. 5 is a flowchart following FIG. 1;

FIG. 6 is a conceptual diagram showing a task pool of the preferred embodiment;

FIG. 7 is a work flowchart of the project;

FIG. 8 is a flowchart following FIG. 7;

FIG. 9 is a conceptual diagram showing a daily executable task pool of the preferred embodiment;

FIG. 10 is a block diagram showing a preferred embodiment of a work management system according to the present invention;

FIG. 11 is a conceptual diagram showing a work management program of FIG. 10.

### DETAILED DESCRIPTION OF PREFERRED EMBODIMENTS

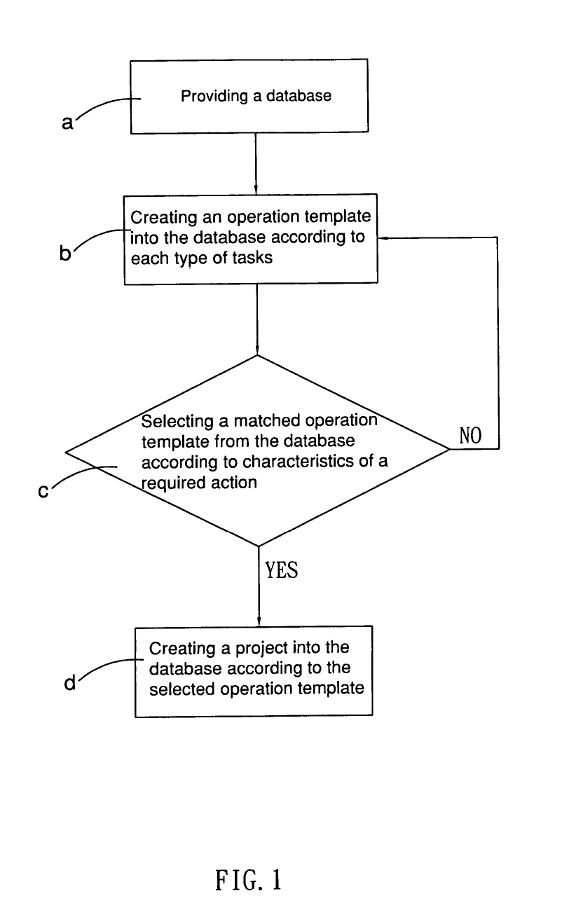

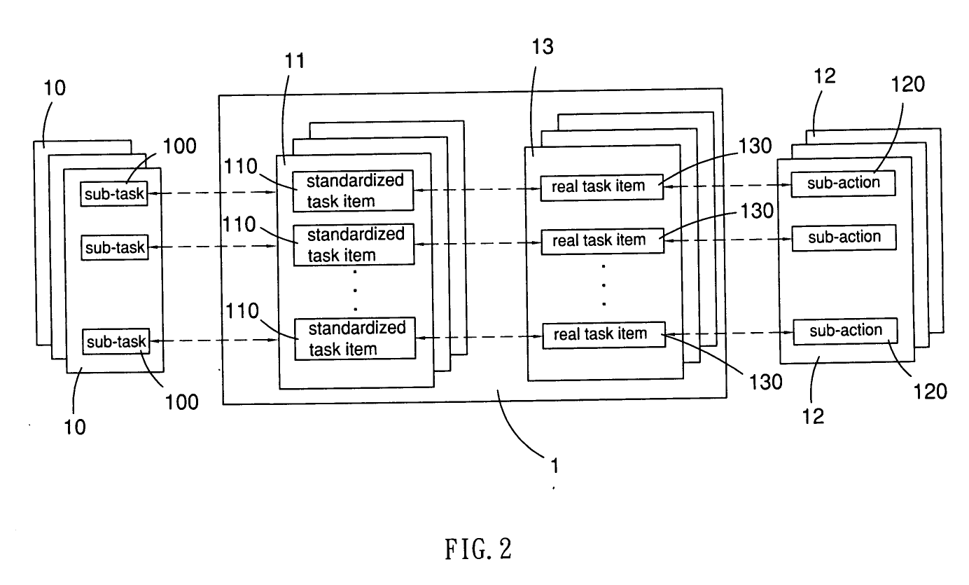

With reference to FIGS. 1 to 2, the present invention will be described for an intelligent work management according to a preferred embodiment of this invention, which comprises steps of: a) providing a database 1; b) creating an operation template 11 into the database 1 according to each type of tasks 10, and c) selecting a matched one of the operation templates 11 from the database 1 according to a required action 12.

When no operation template 11 is found out to match with the required action 12 from the database 1, go back to the step b), and create a corresponding operation template 11 into the database 1 according to the required action 12. Sooner or later, when a new required action of the same type with the prior required action 12 happens, the operation template 11 later created by the step b) can be selected in the need of the new required action.

When one of the operation templates 11 is selected, a step d) is followed as:

d) creating correspondingly a project 13 into the database 1 according to the selected operation template 11.

In the step of b), the task 10 refers to a job required for a specific purpose in a firm, such as an accidental job, a regular job or a periodic job. For instance, setting up a campus recruiting activity can be a kind of job. When taking over the task 10, a project manager of the firm will divide the task 10 into several smaller or simpler subtasks 100 based on the principles of division of labor in order to execute and finish the task 10 efficiently, as shown in FIG. 2. For instance, the task of setting up a campus recruiting activity can be divided into the sub-tasks of “collecting the manpower requirement of each department” and “planning the recruiting activities”.

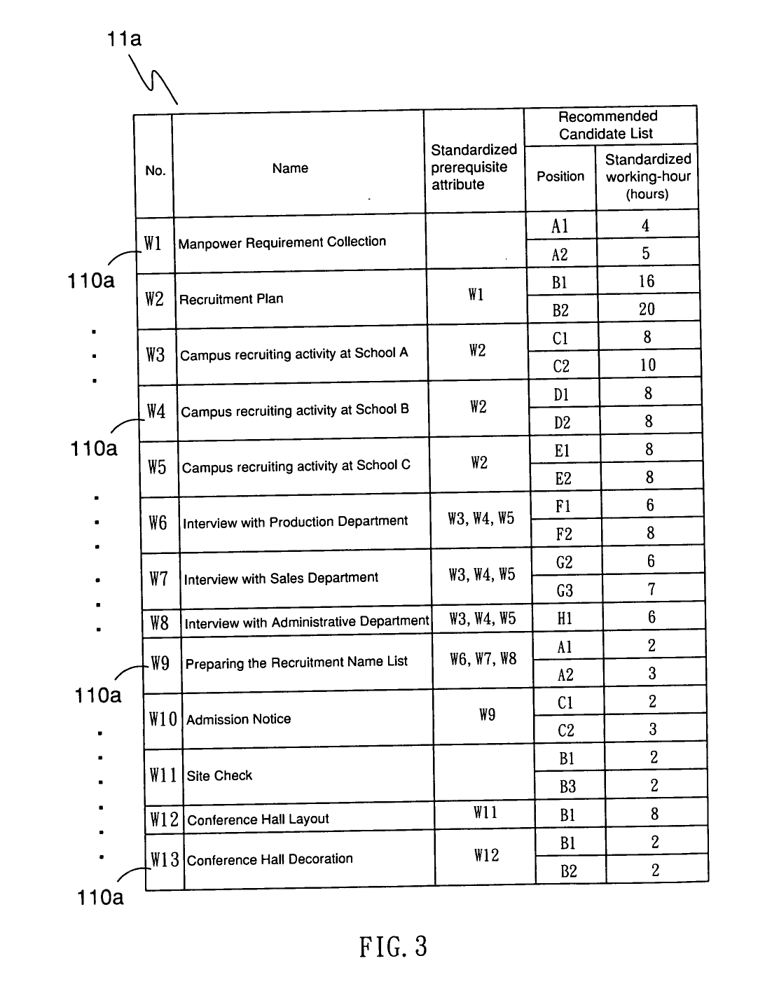

Considering that the task 10 may happen someday in the further, the step b) is to create the corresponding operation template 11 into the database 1 according to the task 10, such as an operation template 1 la called “the campus recruiting activity model” illustrated in FIG. 3.

The operation template 11 has a plurality of standardized task items 110. For instance, the operation template 11a of FIG. 3 has the thirteen standardized task items listed from No. W1 through No. W13. Also, each name of the sub-tasks defines each matter of the sub-tasks.

Referring back to FIG. 2, the standardized task items 110 are created correspondingly according to the sub-tasks 10. Namely, each of the standardized task items 110 stands for each of the sub-tasks derived from the type of task 10. It is to be understood that although each type of tasks 10 may be divided into different sub-tasks, once being divided, a corresponding operation template 11 can be created according to the step b). Each of the operation templates 11 practically shows how to complete the corresponding task through the division of labor as well as a new task happened in the further. The new task can be executed according to the corresponding operation template of same type. There is no need to pay much time to think how to divide the task.

In the step c), the required action 12 refers to a job that the project just receives. If the matter of the required action 12 is similar or the same with the matter of one of the tasks done before, the project manager selects the operation template 11 corresponding to the one of the tasks for the required action 12. For instance, if the required action 12 is the action of setting up a campus recruiting activity, since this type of activity has been held before, and the corresponding operation template 11a has been created in the database 1, as depicted in FIG. 3 that the project manager just only need to select the operation template 11a from the database 1 according to the step c).

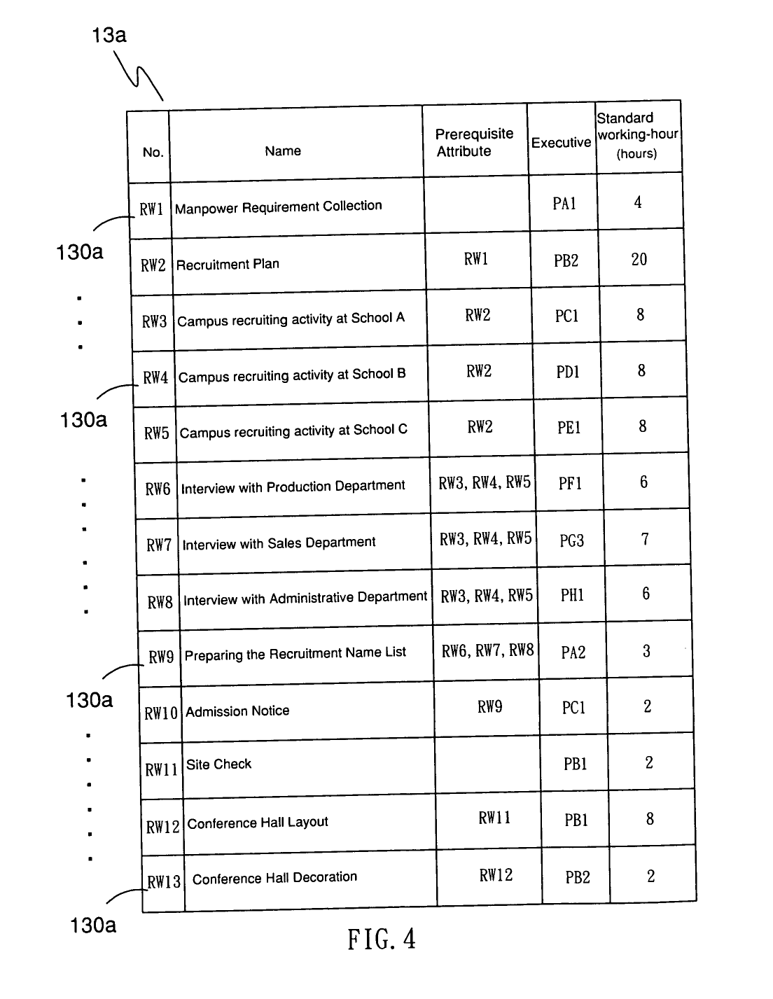

In the step d), the project 13 is correspondingly created according to the operation template 11 of the step c). FIG. 2 shows that the project 13 has a plurality of real task items 130 each correspondingly created in accordance with each of the plurality of standardized task items 110 of the selected operation template 11, wherein each of the plurality of real task items 130 depicts a sub-action 120 derived from the required action 12. For instance, the operation template 11a of FIG. 3 is selected, the step d) is to correspondingly create a new project 13a, as depicted in FIG. 4, into the database 1 according to the operation template 11a. The project 13a is called “campus recruiting activity project”, which including thirteen real task items 130a, namely No. RW1 to RW13. Each name of the real task items 130a is listed on the table. Each matter of the sub-actions corresponding to the real task items 130a is defined in the name thereof.

Compared with the prior arts, the present invention is advantageous in view of saving time and labor. In other words, when a new required action happens, the project manager who is charged with the new required action just need to check whether the kind of required action has happened before and whether the corresponding operation template 11 has been created in the database 1. If the result of the checking is “yes”, that means there is one operation template 11 matched with the new required action for being selected in the database 1. Thus, the project manager just need to select the operation template 11 matched with the new required action, and a corresponding project 13 and real task items 130 thereof will be created automatically into the database 1. The project manager doesn't need to take much care on planning the required action and build the project 13.

In the step c), if the matter of the required action 12 enormously differs from the matter of each of the tasks happened before, this means that there is no operation template 11 matched with the required action 12 for the manager to choose. In the meantime, the manager may either create a new project 13 and a new real task item thereof according to the required action 12 into the database 1 or create a new operation template 11 into the database according to the required action, and select the new created operation template 11 to create a corresponding project 13, as disclosed in the steps of b), c) and d). It is noted that the operation templates in the database can be build up in advance, or be created later according to a present required action 12. The more the executed actions according to the present invention are, the more the operation templates 11 have been built in the database 1, and more types of tasks can be processed in the further.

Since the operation templates 11 in the database 1 will get more and more, the project manager may pick and duplicate a similar prior-created operation template 11 from the database 1 and modify the same into a new operation template 11 according the required action through the step b), and thereby not only saves some time and labor, but also unify the method of creating the operation templates 11, and simplify the method of creating the project 13 uniformly.

The matter of the operation template 11a by the name of “campus recruiting activity model” is shown in greater detail in FIG. 3, wherein:

Each of the standardized task items 110a has a unique number, such as No. W1 to W13.

Each of the standardized task items 110a has a name, such as “collecting the manpower requirement of each department” for the standardized task item No. W1.

Each of the standardized task items 110a has a standardized prerequisite attribute for showing which sub-tasks according to prior standardized task items 110a shall be finished before starting the current sub-task. For instance, the standardized prerequisite attribute of the No.W9 standardized task item 110a is set to W6, W7 and W8. This means that before the sub-task of “preparing the recruitment name list” corresponding to the standardized task item No. W9 is started, the three sub-tasks, namely “interviewing applicants for production department”, “interviewing applicants for sales department” and “interviewing applicants for administrative department”, corresponding to the three standardized task items No. W6, NO. W7 and No. W8, shall be finished. It should be noted that not every one of the standardized prerequisite attributes of the standardized task items 110a should be set to “REAL”, it may be set to “NULL”. For instance, the standardized prerequisite attributes of the standardized task items No. W1 and No. W11 are set to NULL, which means that the sub-tasks according to these two standardized task items are independent of other sub-tasks.

Each of the standardized task items 110a further has a recommended candidate list for setting at least one position, and has at least one standardized working-hour corresponding to the at least one position. The at least one position of the recommended candidate list shows who is qualified for the at least one position so that the sub-task according to each of the standardized task items can be suitably handed over, and the standardized working-hour corresponding to the at least one position defines an estimated usage time for the person for the at least one position to execute and complete the sub-task according to the respective standardized task item. For instance, the recommended candidate list of the No. W1 standardized task item 110a has two positions numbered as A1 and A2, and two standardized working-hours, namely 4 hours and 5 hours, corresponding to position No. A1 and position No. A2. This means that a person with either one of the two positions is qualified for handle the sub-task of “collecting the manpower requirement of each department”. Furthermore, since the position showing an ability level that the persons with the same position may have different performance to the same task. For instance, normally, the work ability and work efficiency of a person with the position of manger are better than those of a person with the position of assistant. Thus, the two standardized working-hours, namely 4 hours and 5 hours, corresponding to position No. A1 and position No. A2 respectively are different. This means that the estimated usage time to execute and complete the sub-task according to the standardized task item No. W1 is four hours for the person with the position No. A1, and five hours for the person with the position No. A2. Moreover, the same person may need different time to deal with different tasks. For instance, the person with position No. A2 needs five hours to execute the sub-task according to the standardized task item No. W1, however, just three hours needed to complete the sub-task according to the standardized task item No. W9.

Each of executives of the real task items is selected based upon the recommended candidate list of the standardized task item corresponding to each of the real task items, and a slate of a human resource database established in the firm. In the human resource database is a plurality of personnel files each showing the position of the person. For instance, it is listed with the position No. Al and the position No. A2 in the recommended candidate list of the standardized task item No. W1 of FIG. 3. Either the person with position No. A1 or the person with position No. A2 can be selected as the executive to execute the real task item No. RW1 via searching through the human resource database according to the position No. A1 and the position No. A2. Suppose that only one person in the position No. A1, and his employee number is PA1; and also only one person in the position No. A2, and his employee number is PA2. In this state, there are two candidates available for choosing concerning the real task item No. RW1.

Each of the standard working-hours of the real task items 130 is copied from the standardized working-hour corresponding to each of the executives selected for each of the real task items 130. For instance, the person with the employee number PA1 is selected for the real task item No. RW1 of FIG. 4, and the corresponding standardized working-time is four hours for the person with the employee number PA1, so that the standard working-hour of the real task item RW1 is four hours. Wherein, the sequence for selecting the executive between the recommend candidate list of each of the real task items 130 and the slate of the human recourse database is decided based upon a daily working-hour of the person for the position of the recommended candidate list, the standard working-hour of the respective real task item 130, and time required for the person to execute all the real task items 130 which are not yet finished. As exampled above, the executive of the real task item No. RW1 may be selected from either the person No. PA1 or the person No. PA2. Thus, according to the corresponding recommend candidate list, the standardized working-hour is four hours for the person No. PA1, and five hours for the person No. PA2. Suppose that the daily working-hour of the person No. PA1 is eight hours, the person No. PA1 can finish the real task item No. RW1 in two days once the project starts in view of deducting the required time for all of the unfinished real task items 130a. Similarly, suppose that the person No. PA2 has a ten-hour daily working-hour, but has more real task items 130a required, the person No. PA2 may need at least four days to finish the real task item No. RW1 once the project starts in view of deducting the required time for all of the unfinished real task items 130a. Hence, in view of the recommend candidate list of the standardized task item 110a corresponding to the real task items No. RW1 and the slate of the human recourse database, the person No. PA1 has higher priority over the person No. PA2. Generally, it is suggested to automatically set the person listed on the topmost as the executive of the corresponding real task item 130, and thereby the project manager may save time and labor on selecting executives.

The matter of the project 13a by the named of “campus recruiting activity project” is shown in greater detail in FIG. 4, wherein:

Each of the real task items 130a has a unique number, such as RW1 through RW13.

Each of the real task items 130a has a unique name, the same as the corresponding standardized task item 110a.

Each of the real task items 90a has a prerequisite attribute showing which sub-actions according to prior real task items 130a shall be finished before starting the current sub-action. In this state, values of each of the prerequisite attributes of the real task items 130a are duplicated from values of each of the standardized prerequisite attributes of the standardized task items 110a. For instance, the values of the prerequisite attribute of the real task item No. RW9 is set to “RW6. RW7 and RW8” in accordance with the standardized prerequisite attribute of the standardized task item No. W9. This means that the sub-action of “preparing the recruitment name list” according to the real task item No. RW9 shall be done after the three sub-actions, namely “interviewing applicants for production department”, “interviewing applicants for sales department”, and “interviewing applicants for administrative department”, are finished according to the real task items No. RW6, No. RW7 and No. RW8. Otherwise, some of the sub-actions are independent, namely without associated with others, according to those real task items 130a whose standardized prerequisite attributes are set to “NULL”, such as the real task items No. RW1 and RW11.

Each of the real task items 130a has an executive and a standard working-hour corresponding to the executive. Each of the executives of the real task items 130a is a person who is assigned a respective sub-action according to the corresponding real task item 130a. Each of the standard working-hours of the real task items 130a is provided for showing an estimated usage time for the executive of the respective real task item to execute the sub-action according to the respective real task item. Each of the executives and the standard working-hours are set by the project manager after the corresponding real task item 130a is created. In this step, the project manager can make a decision according to his own experience.

It should be noted herein that, the operation template 11 and the matter of the standardized task items are not limited to FIG. 3. And each of the project 13 and the corresponding real task item 130 are not limited to FIG. 4. For instance:

Each of the real task items 130 has an actual completion time for showing a completed time when the sub-action according to the real task item 130 is completed. The actual completion time of any of the real task items 130 may be written as not null by the corresponding executive, which showing that the sub-action according to the any of the real task items 130 has been finished by the corresponding executive. Otherwise, that means the sub-action according to the any of the real task items 130 has not yet been finished by the corresponding executive.

Each of the real task items 130 has an actual working-hour showing a usage time which the sub-action according to the real task item 130 takes from the beginning to the end.

When the actual completion time of any of the real task items 130 is set to not null, i.e., the sub-action according to the any of the real task items being finished by the corresponding executive, the standardized working-hour corresponding to the executive of the any of the real task items 130 is reset based upon each of the actual working-hours which the executive of the any of the real task item 130 has ever expended on the same type of the real task items 130. For instance, the standardized working-hour corresponding to the position No. A1 of the standardized task item No. W1 of FIG. 3 is corresponding to the executive of the real task item No. RW 1 of FIG. 4 with the employee number PA1. Accordingly, when the actual completion time of the real task item No. RW1 is set to null, the actual working-hour of the real task item No. RW1 and actual working-hours which the executive with the employee number PA1 has ever used for the same type of real task items 130 will be accumulated and averaged, and the result of the calculation will be copied to the standardized working-hour corresponding to the position No. A1. For instance, if the result of the calculation is three hours, the standardized working-hour corresponding to the position No. A1 will be reset to three hours instead of four hours. This shows that each of the standardized working-hours of the standardized task items 110 is often updated, which displays a real working condition. Accordingly, each of the real task items 130 can be created in reference with a newest standardized working-hour.

The project 13 has a beginning time, and each of the real task items 130 has an estimated beginning time and an estimated completion time. The estimated beginning times and the estimated completion time of each of the real task items are calculated based upon the beginning time, the prerequisite attribute of the real task item 130, the standard working-hour, a daily working-hour of the executive of the real task item, and all the real task items 130 which are not yet finished. For instance, while the beginning time of the project is set on “Aug. 15, 2006”:

The daily working-hour of the executive No. PA1 of the real task item No. RW1 is eight hours per day. And the date that the project begins is on Aug. 15, 2006. Since the prerequisite attribute of the real task item No. RW1 is set to null, that the real task item No. RW1 can be started immediately. In addition, the daily working-hour of the executive No. PA1 on Aug. 15, 2006, namely eight hours, minus the hours required for the executive No. PA1 to execute the other unfinished real task items equals three hours left. The estimated beginning time of the real task item No. RW1 can be analogously calculated to be on Aug. 15, 2006, and the estimated completion time of the real task item No. RW1 is on Aug. 16, 2006.

The prerequisite attribute of the real task item No. RW2 is set to No. RW1, and the standard working-hour is 20 hours. The daily working hour of the executive No. PB2 is six hours. When starting on Aug. 17, 2006, there are three hours left on 17^{th}, five hour left on 18^{th}, six hours left on 19^{th}, a holiday on 20^{th}, four hours left on 21^{th}, and six hours on 22^{th} respectively. Hence, the estimated beginning time of the real task item No. RW2 is on Aug. 17, 2006, i.e., the next day of the estimated completion time of the real task item No. RW1, and the estimated completion of the real task item No. RW2 is on Aug. 22, 2006.

Since the prerequisite attributes of the real task items No. RW3, No. RW4 and No. RW5 are the same number, No. RW2. Each standard working-hours is eight hours. Suppose that each of the daily working hours of the three executives is six hours, and that there is no other unfinished real task items, each of the estimated beginning time of the real task items No. RW3, No. RW4 and No. RW5 is on Aug. 23, 2006, i.e., the next day of the estimated completion time of the real task item RW2, and each of the estimated completion time of the real task items No. RW3, No. RW4 and No. RW5 is on Aug. 24, 2006.

And the rest may be deduced by analogy.

From the introduction of the matters of the operation template 11 and the project 13 as stated above, it is to be understood that the matter of each of the projects 13 and the matter of the corresponding real task items 130 are mainly copied from or referring to the corresponding operation template 11 and the corresponding standardized task items 110. Thus, once the project 13 of the present invention is created, it will take less time to modify or resupply the matter. If the matter of the operation template 11 is created adequately, the matter of the corresponding project 13 will be more complete, without extra need to modify or resupply the same.

Moreover, since some of the required actions happen periodically, the method of the present invention further comprising steps of providing an operation attribute for each of the operation templates 11, and creating a new project 13 periodically and automatically according to a beginning cycle defined by the operation attribute of the operation template selected, and wherein each of the beginning time which the new project 13 created is automatically calculated based upon the beginning cycle. Take yet the “campus recruiting activity” as an example, the campus recruiting activity may be often held in a firm every four months, and eight times continually. In this case, the beginning cycle defined by the operation attribute of the operation template 11a of FIG. 3 is “every four months, and eight times continually”. When the beginning time of a first created project 13a of FIG. 4 is set in Aug. 15, 2006, a second project 13a will be created automatically in Dec. 15, 2006 and a third project 13a will be created in Apr. 15, 2007, and so on. And an eighteenth project 13a will be created in Aug. 15, 2008. Wherein each of the beginning times of the projects is referring to the time when each of the projects is created.

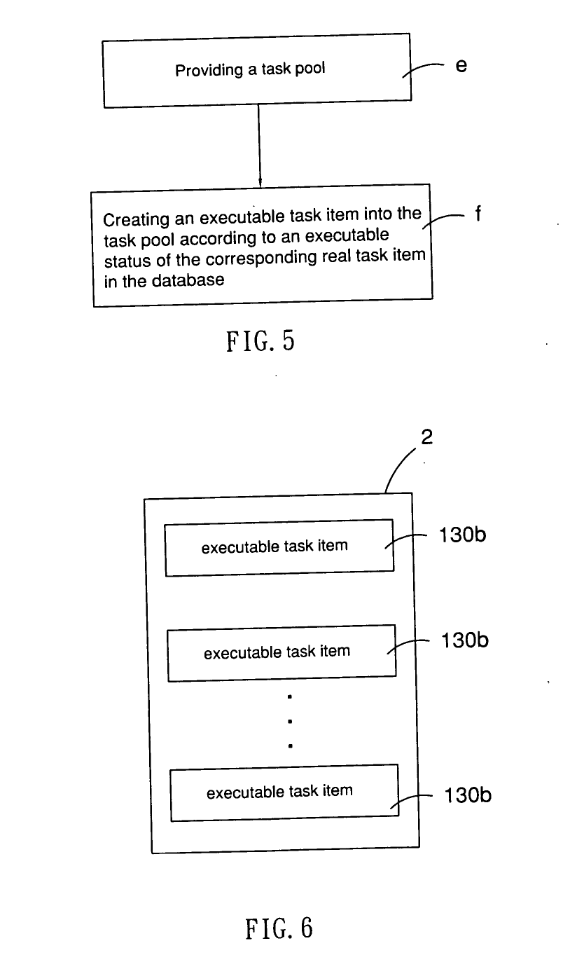

FIGS. 5 and 6 show the method of the present invention further comprising the steps of:

e). providing a task pool 2. The task pool 2 may be as a part of the database 1 mentioned above, or be another database.

f). creating an executable task item 130b into the task pool 2 in accordance with an executable status of the corresponding real task item 130 in the database 1.

Wherein the corresponding real task items 130 with the executable status shall require that the values of the actual completed time and the prerequisite attribute are both set to null in the database 1; and that the value of the actual completion time is set to null, and the actual completion times of the prior real task items 130 shown by the prerequisite attributes are all set to values other than null in the database 1.

The former refers to the real task items 130 in which the prerequisite attribute is set to null, and the corresponding sub-actions have not yet been finished. For instance, once the sub-actions according to the real task items No. RW1 and No. RW11 of FIG. 4 have been finished, the corresponding executable task item 130b will be removed from the task pool 2.

The latter refers to the real task items 130 in which sub-actions according to the prior real task items shown by the prerequisite attribute have been finished. For instance, once the sub-actions according to the prior real task items No. RW3, No. RW4 and No. RW5 of FIG. 4 have been finished, the corresponding executable task items 130b will be created correspondingly into the task pool 2 in accordance with the real task items No. RW6, No. RW7, and No. RW8 and will be removed after the sub-actions according to the three real task items No. RW6, No. RW7, and No. RW8 have been finished.

Accordingly, each of the executives can survey his own executable task items 130b among the task pool 2 so as to understand how many sub-actions is needed to be done and how many sub-actions have been executed but not finished yet. More particularly, the executable task items 130b corresponding to the real task item 130 with the executable status is greatly less than all of the real task items 130, and thereby alleviates management burdens of the executives and displays current burdens which each of the executives faces. This helps the project manager to administer each of the working conditions of the executives.

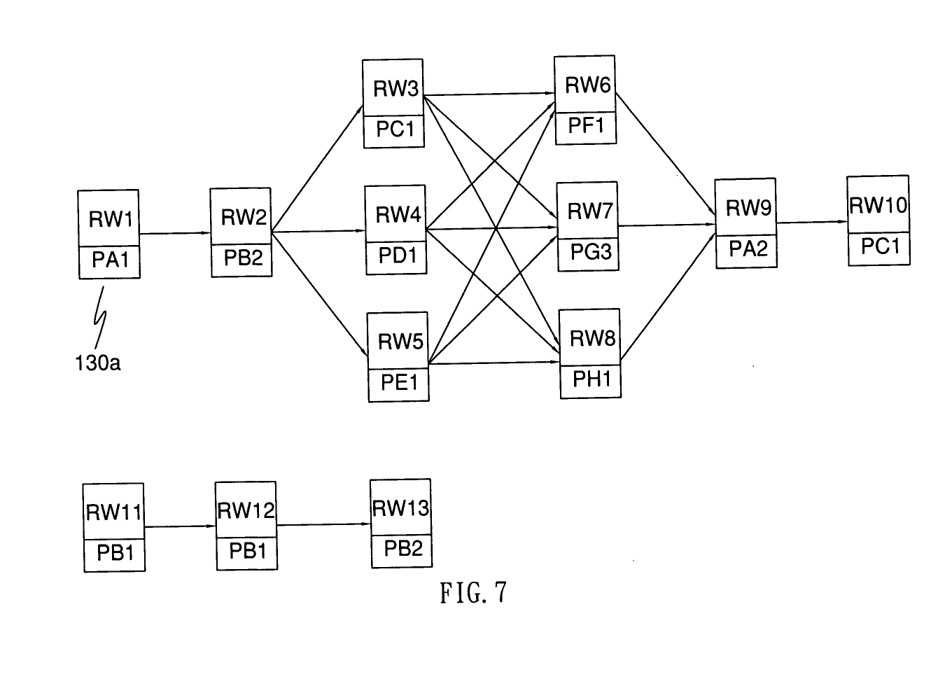

Since each of the real task items 130 has its own prerequisite attribute, that a flowchart of the project can be created automatically according to the matter of the prerequisite attribute of each of the real task items 130. For instance, FIG. 7 shows the flowchart of the project 13a, each of blocks thereof showing one of the real task items 130a; and wherein the upper portion and lower portion of the block shows an item number of the real task item 130a and the employee number of the executive respectively.

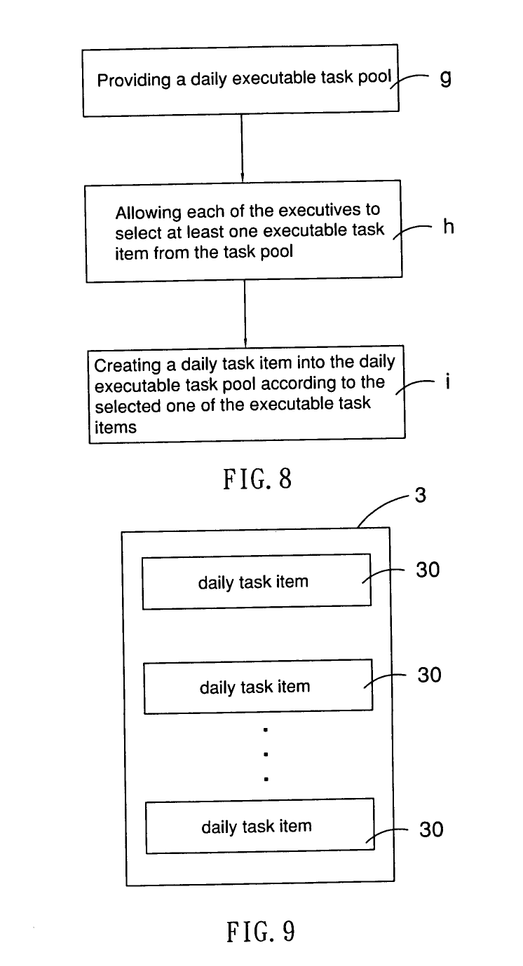

Referring to FIGS. 8 and 9, the method of the present invention disclosed above further comprises steps of:

g). providing a daily executable task pool 3, and wherein the daily executable task pool 3 can be a part of the database 1, or be yet another database;

h). allowing each of the executives to select at least one executable task item 130b from the task pool 2, wherein the sub-action according to the real task item 130 corresponding to the selected one of the executable task items 130b is decided to be executed on a day; and

i). creating a daily task item 30 into the daily executable task pool 3 according to the selected one of the executable task items 130b;

wherein each of the daily task items 30 has an execution working-hour and an execution completion time, and wherein the execution working-hours of the daily task items 30 shows a usage time required for executing the sub-action according to the real task item 130 corresponding to the executable task item 130b concerning the respective daily task items 30; and the execution completion time of the daily task item 30 shows a timing when the sub-action according to the real task item 130 corresponding to the executable task item 130b concerning the respective daily task item 30 is completed. When the execution completion time of any of the daily task items 30 is set to null, it is understood that the sub-action according to the real task item 130 corresponding to the executable task item concerning the any of the daily task items 30 is finished.

Although the sub-action according to the real task item 130 corresponding to the executable task item 130b concerning each of the daily task item 30 is decided to be executed that day, but not necessary to be finished that day. The actual working-hour of the real task item 130 corresponding to the respective executable task items 130b is accumulation of every of execution working-hours of the daily task items 30 that the respective executive handles; and each of the actual completion times of the real task items 130 corresponding to the respective executable task items 130b is copied from each of the execution completion times of the daily task items 30 if each of the execution completion times of the daily task items 30 is set to not null.

In the foregoing description of the daily executable task pool 3 and the daily task items 30, it is understood that each of the executives can manage his own executable task items 130b via the task pool 2, and control his own daily task items 30 via the daily executable task pool 3. Besides, each of the executives can automatically create a daily schedule work sheet according to the daily task items 30 among the daily executable task pool 3.

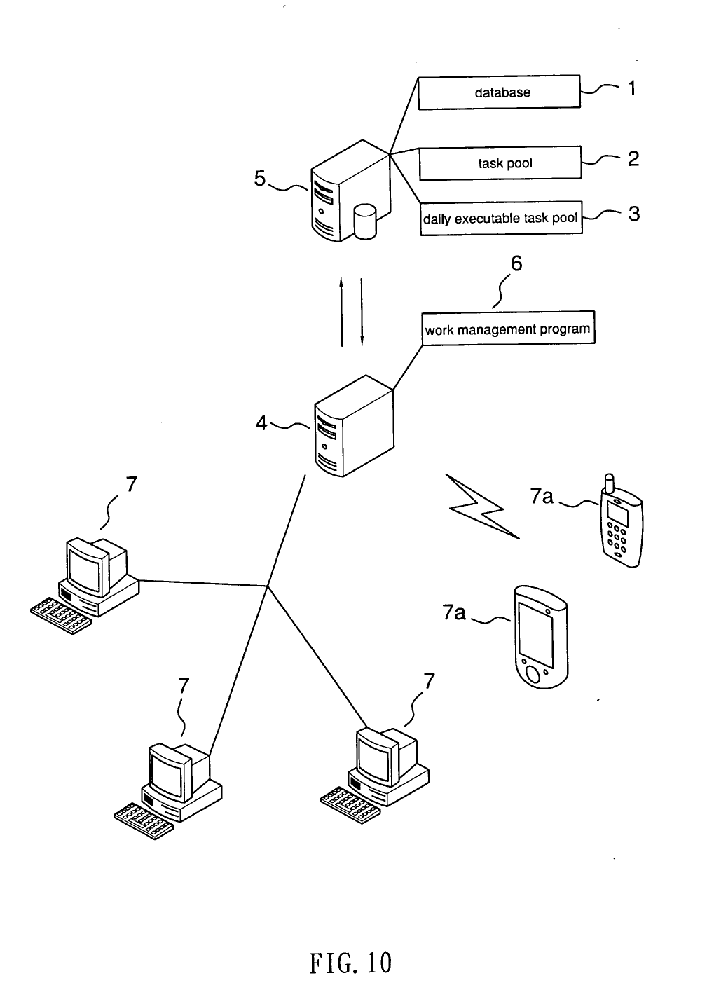

With reference to FIG. 10, an intelligent work management system according to an example of the present invention for practicing the intelligent work management method disclosed above comprises an information processing device 4 and a data storage device 5. The information processing device 4, such as a server-level computer, has a work management program 6. The data storage apparatus 5 has a database 1, a task pool 2, and a daily executable task pool 3, as depicted above. The data storage device may be built up of one computer or several computers. The database 1, the task pool 2, and the daily executable task pool 3 can be put together in the same computer or be scattered in different computers. The information processing device 4 may be linked to one or more computers 7 via a physical network, or be linked to one or more mobile devices 7a, such as a mobile phone, or a personal digital assistant (PDA), via a wireless network. A user may use his own computer 7 or mobile device 7a to activate the work management program 6 of the information processing device 4 so as to create the operation templates 11 and to manage the projects 13. Wherein, the work management program 6 may also be respectively installed in the computers 7 or the mobile devices 7a so that the computers 7 or the mobile devices 7a can access the data storage device 5 via the physical network or the wireless network.

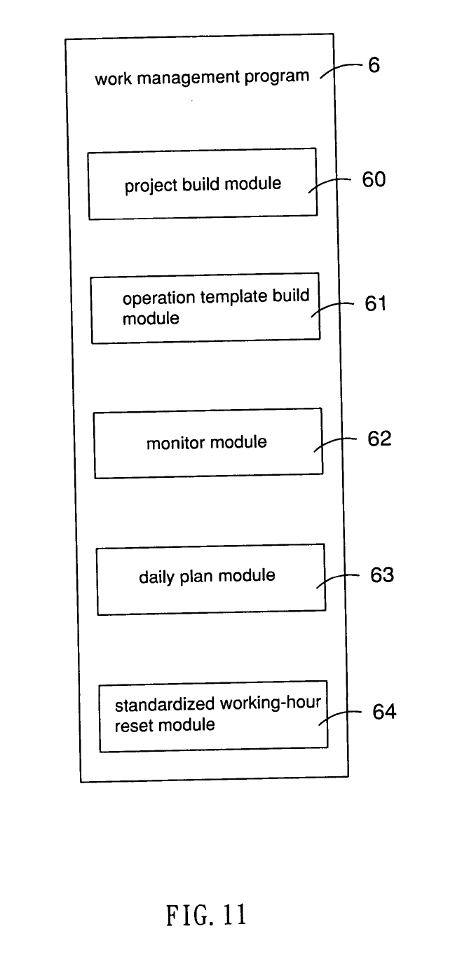

FIG. 11 illustrates the work management program 6, comprising a project build module 60, an operation template build module 61, a monitor module 62 and a daily plan module 63.

The project build module 60 is arranged for allowing a project manager to select a matched one of operation templates 11 from the database 1 in accordance with a required action 12, and to create a project 13 into the database 1 in accordance with the selected operation template 11.

The operation template build module 61 provides an environment to create the operation templates 11 in the database 1.

The monitor module 62 is arranged for creating an executable task item 130b into the task pool 2 in accordance with an executable status of the corresponding real task item 130 in the database, and providing an environment for each of the executives to monitor his own executable task items 130b among the task pool 2.

The daily plan module 63 is arranged for each of the executives to select at least one executable task item 130b from the task pool 2, and for creating a daily task item 30 into the daily executable task pool 3 in accordance with the selected one of the executable task items 110b.

Moreover, the project build module 60 is further arranged to duplicating each of the standardized prerequisite attributes of the standardized task items corresponding to the respective real task items 130 to each of the prerequisite attributes of the real task items 130 respectively while creating the real task items 130.

Furthermore, the project build module 60 is capable of automatically calculating an estimated beginning time and an estimated completion time of the respective real task item 130 in accordance with an beginning time, the prerequisite attribute of the respective real task item 130, a standard working-hour, a daily working-hour of the executive of the respective real task item 130, and all the real task items 130 which are not yet finished.

The project build module 60 is further arranged for periodically and automatically creating a new project 13 in accordance with a beginning cycle defined by an operation attribute of a selected one of the operation templates 11, and calculating a new beginning time of the new project 13 according to the beginning cycle.

The project build module 60 is yet further arranged for retrieving a recommended candidate list of the standardized task item 11 corresponding to the respective real task item 130 from the database 1 and linking to a slate of a human resource database for the respective real task item so as to create a name list for the respective real task item 130; selecting the respective executive of the respective real task item 130 from the name list, and duplicating the standardized working-hour corresponding to the selected executive to the standard working-hour of the respective real task item 130.

In addition, the daily plan module 63 is further arranged to accumulate each of execution working-hours of the daily task items 30 corresponding to the respective executable task items 130b and the respective real task items 130 to each of the actual working-hours of the real task items 130; and to duplicate each of actual completion times of the daily task items 30 corresponding to the respective executable task items 130b concerning each of the real task items 130 to each of actual completion times of the real task items 130 if each of the execution completion times of the daily task items 30 corresponding to the respective executable task items 130b concerning each of the real task items 130 is set to not null.

The operation template build module 61 is further arranged for creating a recommended candidate list for each of the standardized task item 110 into the database 1.

Furthermore, the work management program 6 further includes a standardized working-hour reset module 64 arranging for resetting the standardized working-hour corresponding to the executive selected for charging the respective real task item 130 in accordance with all of the actual working-hours which the executive of the respective real task item 130 has ever expended on the same type of the real task items if any of the actual completion times of the real task items 130 is set to not null.

As noted above concerning the work management program 6, it is understood that the intelligent work management system according to this invention can physically practice the intelligent work management method via the work management program 6, the database 1, the task pool 2 and the daily executable task pool 3, and has all the merits stated above.

What is claimed is:

1. A work management method, comprising:
providing a database;
creating an operation template into the database according to each type of tasks, the operation template having a plurality of standardized task items each serving as a sub-task derived from the type of tasks;
selecting a matched operation template from the database according to characteristics of a required action; and
creating a project into the database according to the selected operation template, the project including a plurality of real task items each correspondingly created in accordance with each of the plurality of standardized task items of the selected operation template, wherein the project depicts the required action, and each of the plurality of real task items depicts a sub-action derived from the required action.

2. The work management method of claim 1, wherein the operation template is created by duplicating and modifying a prior-created operation template.

3. The work management method of claim 1, further comprising:
providing a task pool;
creating an executable task item into the task pool according to an executable status of the corresponding real task item in the database;
wherein each of the plurality of real task items has a prerequisite attribute, an actual working-hour, an actual completion time, and an executive, and wherein the prerequisite attribute shows which sub-actions according to prior real task items shall be finished before starting the current sub-action; the actual working-hour shows a usage time which the sub-action according to the real task item takes from the beginning to the end; the actual completion time shows a completed time when the sub-action according to the real task item is completed; the executive is a person who is assigned the sub-action according to the real task item; and the corresponding real task item with the executable status shall require that the values of the actual completed time and the prerequisite attribute are both set to null in the database; and that the value of the actual completion time is set to null, and the actual completion times of the prior real task items shown by the prerequisite attributes are all set to values other than null in the database.

4. The work management method of claim 3, wherein each of the standardized task items has a standardized prerequisite attribute for showing which sub-tasks according to prior standardized task items shall be finished before starting the current standardized task item, and each of the prerequisite attributes of the real task items is copied from a respective one of the standardized prerequisite attributes of the standardized task items.

5. The work management method of claim 4, wherein the project has a beginning time; each of the real task items has a standard working-hour, an estimated beginning time, and an estimated completion time; and wherein the standard working-hour is provided for showing an estimated usage time for the executive to execute the sub-action according to the real task item; and the estimated beginning time and the estimated completion time are calculated automatically based upon the beginning time, the prerequisite attribute of the real task item, the standard working-hour, a daily working-hour of the executive assigned to the real task item, and all the real task items which are not yet finished.

6. The work management method of claim 5, wherein:
each of the standardized task items has a recommended candidate list for setting at least one position, and has at least one standardized working-hour corresponding to the at least one position; and wherein at least one position of the recommended candidate list shows who is qualified for the at least one position so that the sub-task according to each of the standardized task items can be suitably handed over, and the standardized working-hour corresponding to the at least one position defines an estimated usage time for the person for the at least one position to execute and complete the sub-task according to the respective standardized task item;
each of the executives of the real task items is selected based upon the recommended candidate list of the corresponding standardized task items, and a slate of a human resource database; and
each of the standard working-hours of the real task items is copied from the standardized working-hour corresponding to each of the executives selected for each of the real task items.

7. The work management method of claim 6, wherein when any of the actual completion times of the real task items is set to not null, the standardized working-hour corresponding to the executive of the respective real task item is reset based upon all of the actual working-hours which the executive of the respective real task item has ever expended on the same type of the real task items.

8. The work management method of claim 7, wherein the sequence for selecting the executive between the recommended candidate list of the standardized task item corresponding to the respective real task item and the slate of the human recourse database is decided based upon the daily working-hour of the person for the position of the recommended candidate list, the standard working-hour of the respective real task item, and time required for the person to execute all the real task items which are not yet finished.

9. The work management method of claim 5, further providing an operation attribute for each of the operation templates; and creating a project periodically and automatically according to a beginning cycle defined by the operation attribute of the operation template selected, and wherein each of the beginning time which the project created is automatically calculated based upon the beginning cycle

10. The work management method of claim 9, further comprising steps of:
providing a daily executable task pool;
allowing each of the executives to select at least one executable task item from the task pool, wherein the sub-action according to the real task item corresponding to the selected one of the executable task items is decided to be executed on a day;
creating a daily task item into the daily executable task pool according to the selected one of the executable task items;
wherein each of the daily task items has an execution working-hour and an execution completion time; and wherein the execution working-hour of the daily task item shows a usage time required for executing the sub-action of the real task item corresponding to the executable task item concerning the respective daily task item; the execution completion time of the daily task item shows a timing when the sub-action according to the real task item corresponding to the executable task item concerning the respective daily task item is completed; and wherein each of the actual working-hours of the real task items is accumulation of every of execution working-hours of the daily task items corresponding to the respective executable task items; and each of the actual completion times of the real task items is copied from each of the execution completion times of the daily task items corresponding to the respective executable task items if the execution completion time of the daily task item corresponding to the respective executable task items is set to not null.

11. A work management system, comprising:
a data storage device, having a database provided for storing a plurality of operation templates each having a plurality of standardized task items, wherein each of the operation templates is created based upon a type of tasks, and each of the standardized task items of the respective operation template depicts a sub-task derived from the type of tasks; and
an information processing device, having a work management program for accessing the data storage device;
wherein the work management program includes:
a project build module, allowing a project manager to selecting a matched operation template from the database according to characteristics of a required action, and to create a project into the database in accordance with the selected operation template, the project having a plurality of real task items each created based upon each of the standardized task items of the selected operation template, and wherein the project depicts a required action, and each of the real task items depicts a sub-action derived from the required action.

12. The work management system of claim 11, wherein the work management program further includes an operation template build module for creating the plurality of operation templates into the database.

13. The work management system of claim 11, wherein:
each of real task items has a prerequisite attribute, an actual working-hour, an actual completion time, and an executive; the prerequisite attribute showing which sub-actions according to prior real task items shall be finished before starting the current sub-action; the actual working-hour shows a usage time which the sub-action according to the real task item takes from the beginning to the end of the sub-action; the actual completion time shows a completed time when the sub-action according to the real task item is completed; the executive shows a person who is assigned the sub-action according to the real task item;
the data storage device includes a task pool; and
the work management program further includes a monitor module being arranged for creating an executable task item into the task pool according to an executable status of the corresponding real task item in the database, and providing an environment for each of the executives to monitor the real task items of one's own;
wherein the corresponding real task item with the executable status shall require that the values of the actual completed time and the prerequisite attribute are both null in the database; and that the value of the actual completion time is set to null, and the actual completion times of the prior real task items shown by the prerequisite attributes are all set to values other than null in the database.

14. The work management system of claim 13, wherein:
each of the standardized task items has a standardized prerequisite attribute showing which sub-tasks according to prior standardized task items shall be finished before starting the current sub-action; and
the project build module is arranged for duplicating each of the standardized prerequisite attributes of the standardized task item to the respective one of the prerequisite attributes of the real task item.

15. The work management system of claim 14, wherein the project includes a beginning time, and each of the real task items comprising a standard working-hour, an estimated beginning time and an estimated completion time; and wherein the standard working-hour is provided for showing an estimated usage time for the executive to execute the sub-action according to the real task item; and the project build module is capable of automatically calculating the estimated beginning time and the estimated completion time of each of the real task items in accordance with the beginning time, the prerequisite attribute of the respective real task item, the standard working-hour, a daily working-hour of the executive of the real task item, and all the real task items which are not yet finished.

16. The work management system of claim 15, wherein each of the operation templates has an operation attribute for defining a beginning cycle, and the project build module is arranged for periodically and automatically creating a project in accordance with the beginning cycle defined by the operation attribute of a selected one of the operation templates, and calculating a beginning time of the project according to the beginning cycle.

17. The work management system of claim 16, wherein:
the data storage device further includes a daily executable task pool; and
the work management program further includes a daily plan module being arranged for allowing each of the executives to select at least one executable task item from the task pool, and for creating a daily task item into the daily executable task pool in accordance with the selected one of the executable task items;
wherein the sub-actions according to the real task items corresponding to the selected ones of the executable task items are estimated to be executed on a day; and each of the daily task items includes an execution working-hour and an execution completion time; and wherein the execution working-hour shows a usage time required for executing the sub-action of the real task item corresponding to the respective executable task item concerning the daily task item; the execution completion time shows a completed time when the sub-action according to the real task item corresponding to the respective executable task item concerning the daily task item is completed; and the daily plan module is arranged to add each of execution working-hours of the daily task items corresponding to the respective executable task items and the respective real task items to each of the actual working-hours of the real task items; and to duplicate each of the execution completion times of the daily task items corresponding to the respective executable task items concerning each of the real task items to each of the actual completion times of the real task items if each of the execution completion times of the daily task items corresponding to the respective executable task items concerning each of the real task items is set to not null.

18. The work management system of claim 15, wherein:
the operation template build module is arranged for creating a recommended candidate list for each of the standardized task item into the database in order to set at least one position; and at least one standardized working-hour corresponding to the at least one position, and wherein the at least one position of the recommended candidate list shows who is qualified for the at least one position so that the sub-task according to each of the standardized task items is suitable to be handed over, and the standardized working-hour corresponding to the at least one position defines an estimated usage time for the person qualified for the at least one position to execute and complete the sub-task according to the respective standardized task item;
the project build module is arranged for obtaining the recommended candidate list of the standardized task item corresponding to a respective one of the real task items from the database, linking to a slate of a human resource database; selecting the executive of the respective real task item from the recommended candidate list of the standardized task item corresponding to the respective real task item, and the slate of the human resource database; and duplicating the standardized working-hour corresponding to the executive selected for charging the respective real task item to the standard working-hour of the respective real task item.

19. The work management system of claim 18, wherein the work management program further includes a standardized working-hour reset module arranging for resetting the standardized working-hour corresponding to the executive selected for charging the respective real task item in accordance with each of the actual working-hours which the executive of the respective real task item has ever taken for the same type of the real task items if any of the actual completion times of the real task items is set to not null.
